(19) United States
(12) Patent Application Publication
(10) Pub. No.: US 2015/0025738 A1
(43) Pub. Date: Jan. 22, 2015

(54) METHODS AND APPARATUS FOR AUTOMATIC CLIMATE CONTROL IN A VEHICLE BASED ON CLOTHING INSULATIVE FACTOR

(71) Applicant: GM GLOBAL TECHNOLOGY OPERATIONS LLC, Detroit, MI (US)

(72) Inventors: TODD M. TUMAS, TAYLOR, MI (US); JEFFREY A. BOZEMAN, ROCHESTER, MI (US)

(73) Assignee: GM GLOBAL TECHNOLOGY OPERATIONS LLC, Detroit, MI (US)

(21) Appl. No.: 13/947,796

(22) Filed: Jul. 22, 2013

(51) Int. Cl. B60H 1/00

(52) U.S. Cl. CPC B60H 1/00742
USPC 701/36

(57) ABSTRACT

An automatic climate control system of a motor vehicle, and related operating methods, are provided. The automatic climate control system determines a clothing insulative factor for an occupant of the motor vehicle; calculates a model temperature condition based on a temperature set-point and the clothing insulative factor; obtains a current existing temperature condition; calculates a difference between the model temperature condition and the current existing temperature condition; and changes at least one of a plurality of parameters to adjust the current existing temperature condition based on the difference.

### TECHNICAL FIELD

The technical field generally relates to motor vehicle climate control systems, and more particularly relates to automatic motor vehicle climate control systems that factor the clothing level of an occupant to provide thermal comfort.

### BACKGROUND

A typical automotive vehicle with an automatic climate control system utilizes user input along with input from various interior and exterior environmental sensors indicating interior and exterior ambient temperatures, solar load, automotive vehicle velocity, etc., to determine an appropriate discharge air temperature, air flow delivery method, and climate control system fan speed to determine and maintain a thermal comfort level for occupants of a passenger compartment. However, this thermal comfort level calculation is the same for all passengers, without taking into account factors that may distinguish a thermal comfort level for one passenger from that of another passenger. One such factor, the clothing worn by each passenger, may affect thermal comfort level significantly. While one passenger may wear a heavy coat, jeans, and boots, another passenger may wear a pair of shorts, lightweight shirt, and sandals, and yet the automatic climate control system would not have the ability to distinguish between the two and would accommodate one level of thermal comfort only.

Accordingly, it is desirable to recognize a clothing level for each passenger, and to uniquely accommodate each thermal comfort level that accompanies passenger clothing choice. Furthermore, other desirable features and characteristics of the present invention will become apparent from the subsequent detailed description and the appended claims, taken in conjunction with the accompanying drawings and the foregoing technical field and background.

### BRIEF SUMMARY OF EMBODIMENTS

Some embodiments provide a method for operating an automatic climate control system of a motor vehicle. The method determines a clothing insulative factor for an occupant of the motor vehicle; calculates a model temperature condition based on a temperature set-point and the clothing insulative factor; obtains a current existing temperature condition; calculates a difference between the model temperature condition and the current existing temperature condition; and changes at least one of a plurality of parameters to adjust the current existing temperature condition based on the difference.

Some embodiments provide a motor vehicle heating, ventilation, and air conditioning (HVAC) apparatus. The HVAC apparatus includes a user interface, configured to receive a user-selected temperature condition; at least one infrared (IR) sensor, configured to collect temperature data; a plurality of sensors, configured to collect and transmit environmental data when polled. The HVAC apparatus further includes an HVAC control unit, configured to determine a clothing insulative factor based on the collected temperature data; calculate a corrected temperature condition based on the user-selected temperature condition and the clothing insulative factor; obtain an existing temperature condition; calculate a difference between the corrected temperature condition and the existing temperature condition; and adjust the existing temperature condition toward the corrected temperature condition, based on the calculated difference.

Some embodiments provide a method of operating a motor vehicle automatic climate control system. The method obtains one of a plurality of pre-defined levels of clothing insulation for an occupant of a motor vehicle; determines a modified temperature condition using the level of clothing insulation and a pre-defined temperature condition; determines a current temperature condition; calculates a difference between the modified temperature condition and the current temperature condition; and adjusts fan speed, air flow delivery mode, and air flow output temperature of the automatic climate control system to reduce a difference between the current temperature condition and the modified temperature condition.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes an automatic climate control system with heating, ventilating, and air conditioning (HVAC) functionality, in accordance with an exemplary embodiment;

FIG. 2 is a diagram of a typical motor vehicle dashboard, including air flow discharge vents associated with an HVAC system, in accordance with an embodiment;

FIG. 3 is a diagram of potential thermal analyzed areas of an occupant of a motor vehicle included in the determination of a clothing insulative factor, in accordance with an embodiment;

FIG. 4 is a diagram illustrating a grid overlying a thermal-mapping of two occupants of a motor vehicle, in accordance with an embodiment; and

FIG. 5 is a flow chart that illustrates an embodiment of operating a climate control system using a clothing insulative factor.

### DETAILED DESCRIPTION

The following detailed description is merely exemplary in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

### DETAILED DESCRIPTION

The subject matter presented herein relates to methods used to regulate the thermal comfort of occupants of a motor vehicle. In some embodiments, an automatic climate control system regulates a temperature condition of the passenger compartment of a vehicle based on a preferred control temperature input by a passenger and a detected level of clothing insulation worn by the passenger, with the objective that a passenger may choose one desired temperature and an automatic climate control system will accommodate different levels of clothing of the passenger to achieve the same level of thermal comfort.

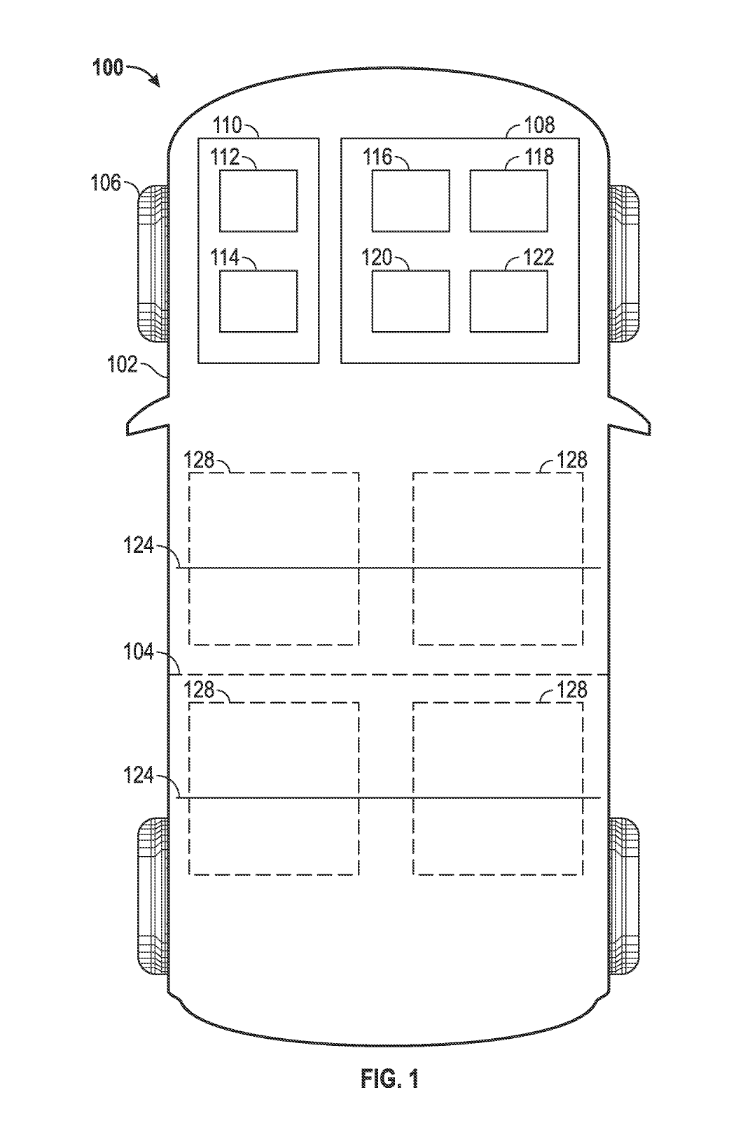

Referring now to the drawings, FIG. 1 is a functional block diagram of a vehicle 100, such as an automobile, that includes an automatic climate control system with heating, ventilating, and air conditioning (HVAC) functionality, in accordance with an exemplary embodiment. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 includes a body 102 that is arranged on a chassis 104. The body 102 substantially encloses the other components of the vehicle 100. The body 102 and the chassis 104 may jointly form a frame.

As depicted in FIG. 1, the vehicle 100 also includes a plurality of wheels 106, a drive system 110, and a climate control system 108. The wheels 106 are each rotationally coupled to the chassis 104 near a respective corner of the body 102 to facilitate movement of the vehicle 100. In a preferred embodiment, the vehicle 100 includes four wheels, although this may vary in other embodiments (for example for trucks and certain other automotive vehicles).

The drive system 110 is mounted on the chassis 104, and drives the wheels 106. The drive system 110 preferably comprises a propulsion system. In certain exemplary embodiments, the drive system 110 comprises a combustion engine 112 and/or an electric motor/generator, coupled with a transmission 114 thereof. In certain embodiments, the drive system 110 may vary, and/or two or more drive systems 110 may be used. By way of example, the vehicle 100 may also incorporate any one of, or combination of, a number of different types of electrical propulsion systems such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

The climate control system 108 is configured to control the temperature within one or more passenger compartments of a motor vehicle, and may be part of a heating, ventilating, and air conditioning (HVAC) system as is well known in the art, or alternatively, may be a standalone system. The climate control system 108 uses outside air or recirculating air to heat and cool the vehicle 100, and to provide one or more climate controlled passenger zones 128. In this regard, a climate controlled passenger zone 128 may be associated with a front row 124 and/or a back row 126 of the vehicle 100. In a preferred embodiment, the climate control system 108 comprises an air conditioning/heating system for the vehicle 100 that includes at least a compressor, heat exchanger, and a fan, which are not shown in FIG. 1. These particular parts are integral to providing thermal comfort to passengers of a vehicle 100 via a climate control system 108, but contain functionality which is outside of the scope of this application. Although FIG. 1 depicts a typical vehicle 100 that accommodates four passengers in four defined climate controlled passenger zones 128, the subject matter presented herein can be utilized with other vehicle configurations having any number (including only one) of climate controlled passenger zones 128.

In accordance with some embodiments, the climate control system 108 may include, without limitation: a climate control module 116; a user interface 118; one or more thermal data collecting sensors 120; and a plurality of interior and exterior environmental sensors 122. These elements and features of a climate control system 108 may be operatively associated with one another, coupled to one another, or otherwise configured to cooperate with one another as needed to support the desired functionality—in particular, controlling the unique thermal comfort of each passenger based on the clothing worn while inside the vehicle 100, as described herein. For ease of illustration and clarity, the various physical, electrical, and logical couplings and interconnections for these elements and features are not depicted in FIG. 1. Moreover, it should be appreciated that embodiments of the climate control system 108 will include other elements, modules, and features that cooperate to support the desired functionality. For simplicity, FIG. 1 only depicts certain elements that relate to the automatic climate control techniques described in more detail below.

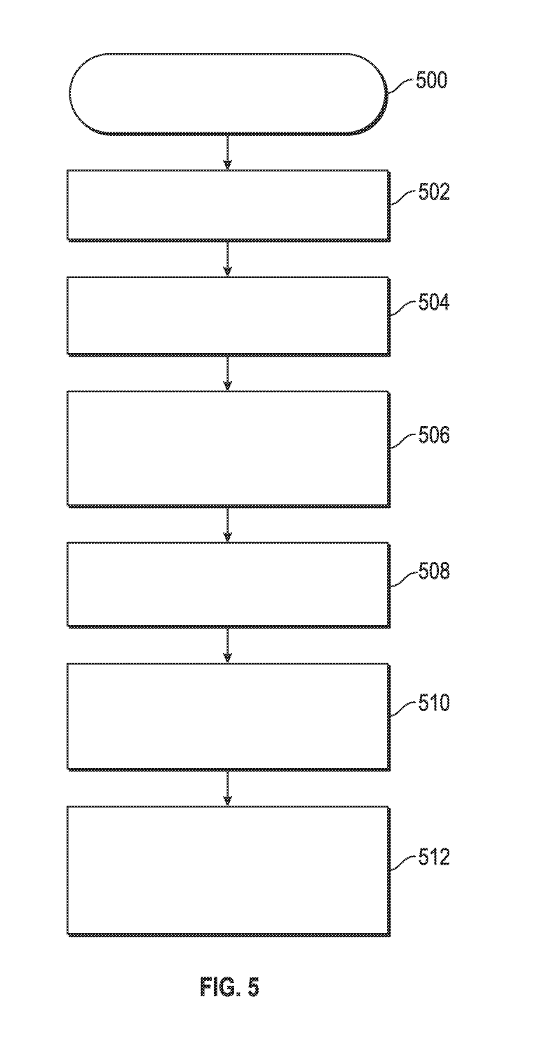

The climate control module 116 may be implemented using any application specific integrated circuit (ASIC), electronic circuit, processor (shared, dedicated, or group) and memory that execute one or more software or firmware programs, a combinational logic circuit, and/or other suitable components that provide the described functionality. In the example provided, the climate control module 116 executes the tasks of the processes described herein, such as the tasks of the process 500 described below in connection with FIG. 5.

The user interface 118 accepts information from a vehicle occupant (typically the driver of the vehicle 100) as to a climate control preference, otherwise known as a set-point. In certain embodiments, the user interface 118 is part of a user input climate control panel of the vehicle 100. In some embodiments, the user interface 118 is coupled to one or more switches, knobs, and/or other user interfaces disposed on or near a dashboard of the vehicle 100. The vehicle 100 may also include one or more secondary user interfaces positioned at or near the rear passenger zones 128 for use by passengers seated in the back row 126, or a plurality of back rows. The user interface 118 is communicatively coupled to the climate control module 116 for transmission and processing of user input within the climate control system 108.

A set-point reflects a temperature, selected by an occupant of the vehicle 100, that is thought to be comfortable for the occupant and which the occupant would prefer to maintain for the duration of time in which he/she is present within the vehicle and in which the vehicle 100, and consequently the climate control system 108, is switched on. The set-point itself is generally a numeric temperature value that is chosen or entered by the user via a user interface. In certain embodiments, the set-point may be a temperature (in degrees), and in some embodiments, the set-point may be something that is indicative of a temperature, such as a knob or slider position indicating cold, warm, and hot; blue-red slider positions; or I, II, III, IV icons associated with a knob, slider, or other climate control indicator. In certain embodiments, the set-point is selected to maintain comfort for the entire vehicle. In other embodiments, each occupant of the vehicle may have a unique set-point, which may be accommodated utilizing a plurality of climate controlled passenger zones 128.

A set-point indicates a desired level of thermal comfort for an occupant at a particular temperature, either within the entire passenger compartment of a vehicle 100 or within a specific region (i.e., a climate controlled passenger zone 128) of the passenger compartment of a vehicle 100. To provide this desired level of thermal comfort, the climate control system 108 must make adjustments to an existing temperature condition, including additional criteria, other than ambient temperature. An ambient temperature reading within the passenger compartment of a vehicle 100 is insufficient to describe an applicable temperature condition because the passenger compartment of a vehicle 100 includes a stratified thermal condition. A stratified thermal condition indicates that there are different thermal physiological results in different areas of the enclosed passenger compartment of a vehicle 100. This is largely due to varying levels of convection and sunlight, which depend on the locations of the plurality of vents of the climate control system 108, and the locations of the large percentage of surface area of the vehicle 100 that includes glass windows.

Basic functionality of the climate control vents includes discharging air at a specific temperature, which contributes to an overall thermal comfort level for one or more passengers. However, the temperature of discharged air flow is not the only adjustable parameter affecting an overall occupant thermal physiological condition of a vehicle; the climate control vents also discharge air at a specified and controlled fan speed, and discharge air from specific climate control system vents directed in specific directions and residing within certain areas of a vehicle 100. This additional functionality effectively manages a level of convection at the locations of the vents themselves, in addition to effectively managing discharged air temperature. It follows that convection levels will be higher in an area directly receiving discharged air from a vent or plurality of vents, or in an area directly receiving air that is discharged at a higher speed and pressure, and this contributes to a variance in temperature condition and/or occupant thermal comfort in these areas.

The glass windows allow for a significant amount of sunlight inside the vehicle 100. Heat due to radiation from the sun will be most acutely felt in areas close to the windows themselves, whereas another area of the passenger compartment, which might be further away from the sunlight or might be a region of the passenger compartment without a window at all, will feel less radiant heat from the sun and a lower resulting thermal sensation in that specific area.

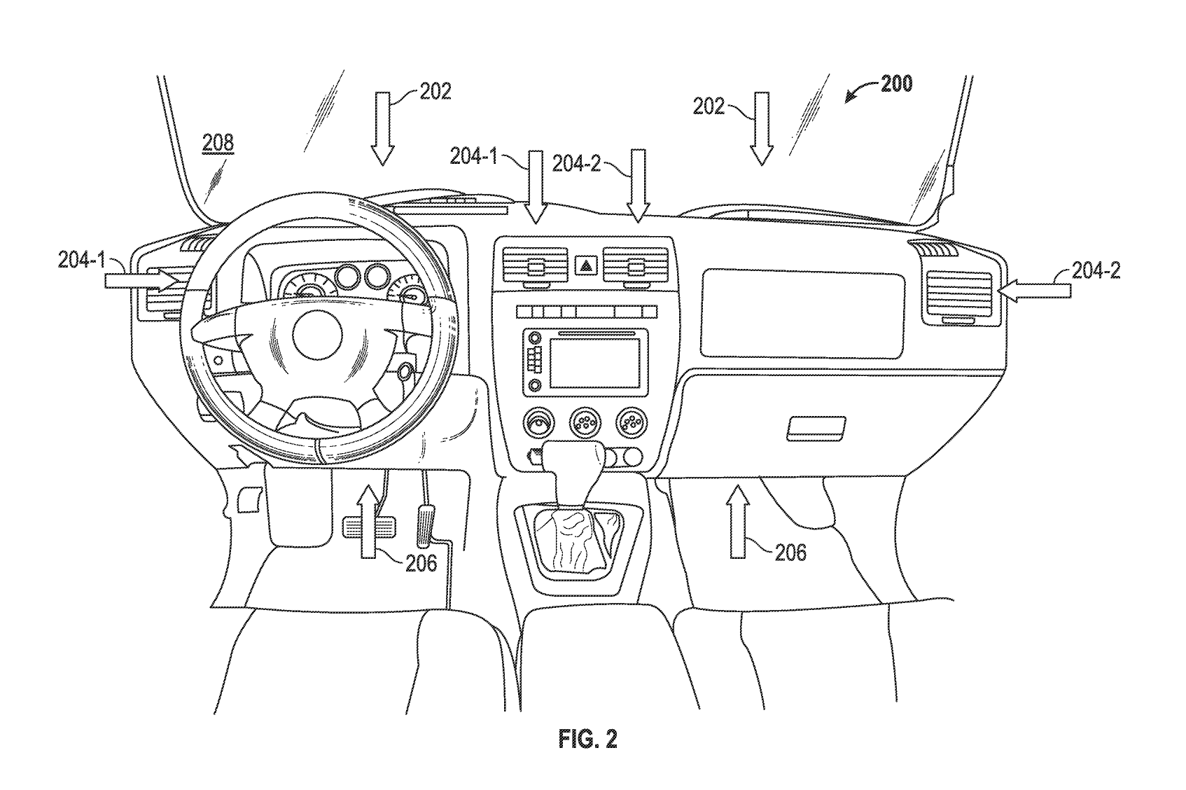

FIG. 2 is a diagram of a typical motor vehicle dashboard 200, including air flow discharge vents (202, 204-1, 204-2, 206) associated with a climate control system (shown as 108 in FIG. 1), as would be used in regulating the level of convection in the passenger compartment of a vehicle (shown as 100 in FIG. 1). As shown, forward-facing air flow discharge vents (204-1, 204-2) direct any air flow discharge toward the back of the vehicle and toward the front of forward-facing passengers. Forward-facing air flow discharge vents 204-1 direct air flow discharge toward the driver of the vehicle, and forward-facing air flow discharge vents 204-2 direct air flow discharge toward a front-seat passenger of the vehicle. Defroster air vents 202 direct air flow discharge toward the windshield 208 of the vehicle, and floor air vents 206 direct air flow discharge toward the floor of the vehicle. Air flow discharge may be directed outward from one or more sets of vents simultaneously, and does not require the use of all vents at all times. In some embodiments, the groups of vents previously described, and/or other vents located in the vehicle, may direct air flow discharge in directions other than those previously described. In some embodiments, additional air flow discharge vents may be located near passenger seats in a back region, a middle region, and/or any other region of a vehicle.

Returning now to FIG. 1, when a user selects his/her preferred set-point, that set-point is reflective of a desired thermal environment at which the user will maintain thermal comfort. In certain practical embodiments, a set-point may correspond to a user-selected temperature (e.g., 70 degrees), a user-selected word or phrase that indicates a temperature (e.g., “cold” or “warm” or “hot”), a user-selected color, icon, or marking that corresponds to a temperature (e.g., blue for cooler temperatures and red for warmer temperatures), or the like. The temperature condition corresponding to a set-point includes both an ambient temperature and a level of convection, provided by the climate control system 108, both of which contribute to an overall thermal sensation. This overall environment condition, achieved through regulation of discharge air temperature, discharge air flow delivery mode, and discharge air speed and pressure, contribute to a feeling of thermal comfort for one or more occupants of the vehicle 100. The goal is to achieve thermal comfort either throughout the passenger compartment of the vehicle 100, or to achieve thermal comfort within a climate controlled passenger zone 128 of the passenger compartment, by manipulating air temperature and convection within the space.

The set-point of the climate control system 108 is input by a driver or other occupant of the vehicle 100 via the user interface 118. There may be one or more set-points, each associated with a particular climate controlled passenger zone 128. Each climate controlled passenger zone 128 includes a specified region of a vehicle 100 with its own associated and independently delivered thermal sensation. In certain embodiments, one set-point will determine a level of thermal comfort for the entire passenger compartment. In other embodiments, two or more set-points will determine a level of thermal comfort for two or more pre-defined regions of the passenger compartment. For example, a back seat of a minivan may have its own climate control delivery system, operating independently from the climate control delivery system of that of the driver seat of the same minivan. In this example, both the driver seat area and the backseat area of the minivan share the same air conditioning/heating system, and the same climate control module 116 will execute the appropriate climate control program. However, the climate control delivery systems associated with the backseat and the driver seat have the ability to deliver different air temperatures, different air flow speeds and pressures due to fan speed, and different air delivery modes, which would dictate which vents are used to discharge air from the air conditioning/heating system. The separate and distinct climate control delivery systems for the specified regions of the example minivan provide the ability to achieve two different levels of thermal comfort for passengers in at least two different climate controlled passenger zones 128.

Two options available for user selection via the user interface 118 are minimum and maximum values at the top and the bottom of the available temperature scale of the climate control system 108 within the vehicle 100. In certain embodiments, these minimum and maximum values are 60 degrees and 90 degrees, respectively. However, in other embodiments, the maximum and minimum values may be set according to designer preference. Selection of either the maximum or minimum value is treated as a manual system-override, and the automatic climate control functionality based on the clothing insulative factor is disabled if either value is selected as the set-point. Upon selection of either of these options, the climate control system 108 recognizes the input temperature as an ideal temperature and operates utilizing conventional methods of regulating interior temperature of a passenger compartment of a vehicle 100.

The one or more thermal data collecting sensors 120 located within the passenger compartment of a vehicle 100 are positioned and configured to perform a scan of a pre-determined area of the passenger compartment, and to obtain temperature data associated with occupants of the vehicle 100 for the purpose of transferring this information to the climate control module 116 for further calculation of a clothing insulative factor. In certain embodiments, the one or more thermal data collecting sensors 120 include infrared (IR) sensors. The pre-determined area is determined during the design process and, in some embodiments, will not have the capability to be changed post-production. In other embodiments, the position, orientation, and/or “line of sight” of any or all of the thermal data collecting sensors 120 could be adjustable.

Clothing insulative factors are determined for each occupied seat of the vehicle 100, and occupancy of each seat of the vehicle is known to the climate control module 116 before the thermal data collecting sensors 120 perform a scan of the pre-determined area of the passenger compartment. Data regarding occupancy of each seat of the vehicle is stored within the climate control module 116. In certain embodiments, this data is determined by the climate control module 116, and in other embodiments, the data is determined by another module within the vehicle 100 and communicated to the climate control module 116 for further calculation of the clothing insulative factor.

In certain embodiments, at each climate controlled passenger zone 128, at least one thermal data collecting sensor 120 is positioned to collect data, including a temperature mapping, associated with the occupants located within that particular climate controlled passenger zone 128. In certain embodiments, the thermal data collecting sensors 120 may be mounted on a rearview mirror of a vehicle, and in other embodiments, the thermal data collecting sensors 120 may be otherwise coupled, attached, mounted, placed, and/or positioned at any useful location on the inside or outside of the passenger compartment of a vehicle, which is deemed appropriate for collecting the required thermal data. In some embodiments, thermal data collecting sensors 120 are positioned to collect data for a driver and front-seat passenger only; in other embodiments, thermal data collecting sensors 120 may be positioned to collect data for all passengers within a passenger compartment.

A temperature mapping, created by a thermal data collecting sensor 120, may include “hot” zones, depicting increased temperature (showing a reading of approximately 33 degrees Celsius or approximately 90 degrees Fahrenheit, reflecting the average human body skin temperature), and indicating areas of the occupant that are not covered by clothing. Areas of bare skin on an occupant are distinctive within an IR thermal mapping, in certain embodiments, due to increased temperature and the resulting color contrast. For example, the face of an occupant is usually not covered by clothing, and would likely appear in a brightly-colored section of an IR mapping, which is illustrative of a temperature at, or close to, 33 degrees Celsius.

The temperature mapping may further include “cold” zones, depicting a lower temperature than previously described in the context of “hot” zones, and indicating areas of the occupant that are covered by clothing. Generally, these “cold” zones are discovered using temperature data from the “hot” zone, previously acquired data detailing a current, ambient, interior temperature of the passenger compartment, and newly acquired temperature data associated with a scanned area of an occupant. If a scanned area of an occupant of the passenger compartment reflects a temperature data value that falls between the temperature data values for the “hot” zone and the ambient temperature, then the scanned area is determined to be covered with clothing. In certain embodiments, the closer the scanned temperature is to the ambient interior temperature of the vehicle, the higher the level of clothing insulation on the occupant of the vehicle, and consequently, the heavier the garment(s) covering the scanned area of the occupant. In some embodiments, the closer the scanned temperature is to the expected human body skin temperature, the lower the level of clothing insulation on the occupant of the vehicle, and consequently, the lighter the garment(s) covering the scanned area of the occupant.

For example, in certain embodiments, if the ambient interior temperature of a vehicle 100 is measured to be 20 degrees Celsius, and a “hot” zone temperature value (equivalent to the average human body skin temperature) is known to be 33 degrees Celsius, and a scanned area of an occupant reflects a temperature of 25 degrees Celsius, this information is interpreted to mean that the scanned area of the occupant is covered with clothing. In this example, it is determined that the scanned area of the occupant is covered with clothing because the scanned temperature falls between the known current ambient temperature of the interior of the vehicle (here, 20 degrees Celsius), and the known average human body skin temperature (33 degrees Celsius).

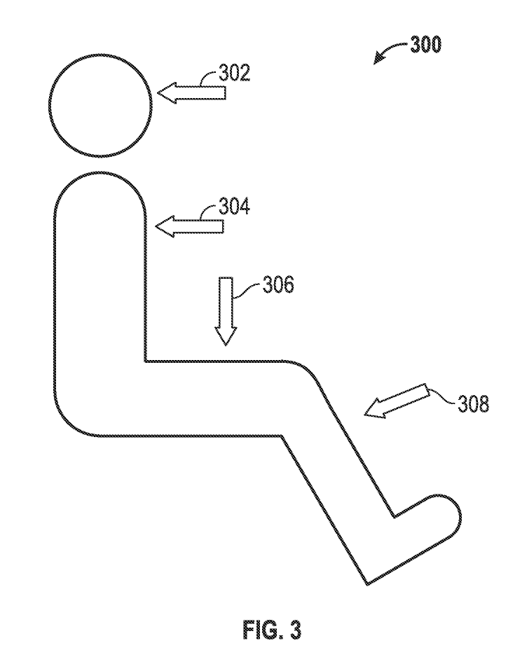

As shown in FIG. 3, areas of an occupant 300 typically scanned by the thermal data collecting sensors (shown as 120 in FIG. 1) may include, without limitation: a face 302, a chest 304, a lap 306, and one or more legs 308 of the occupant. In certain embodiments, one or more arms (not shown) of the occupant may also be scanned.

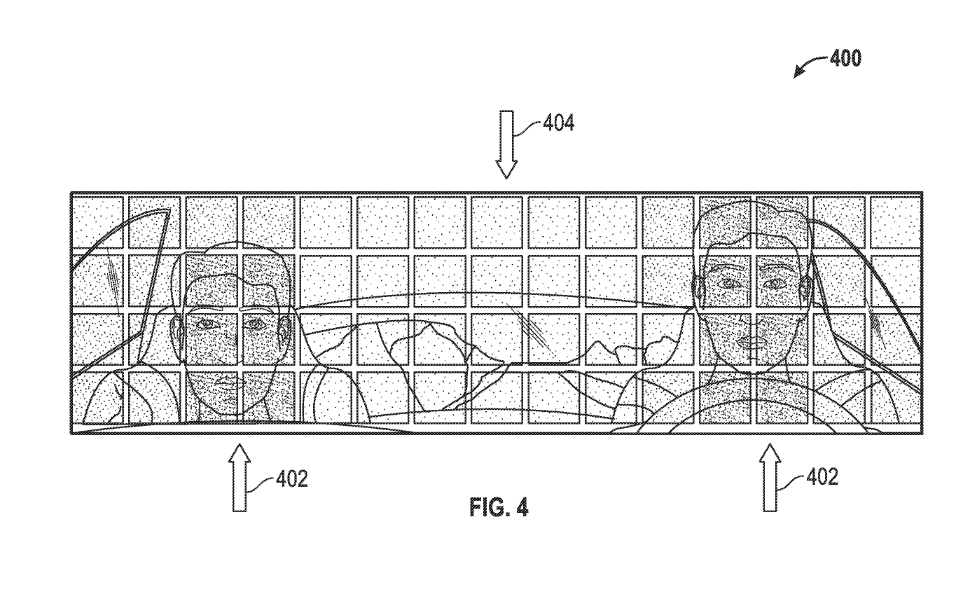

FIG. 4 depicts a grid overlying an infrared (IR) thermal-mapping 400 of two occupants of a motor vehicle, in accordance with an embodiment. In the example shown, the shading in the regions corresponding to the occupants' faces 402 in the grid contrast with the shading appearing in the empty sections of the grid 404. The different shading used in FIG. 4 represents different detected temperatures. In practice, the IR thermal-mapping 400 may correspond to a color mapping that depicts temperature gradients wherein brighter colors indicate higher temperatures, and in some embodiments, indicate an expected approximate temperature of 33 degrees Celsius at the face 402 of each occupant.

Returning now to FIG. 1, the plurality of interior and exterior environmental sensors 122 collect and provide environmental data to the climate control module 116 for further processing and use during execution of climate control programs. The interior and exterior environmental sensors 122 may collect, for example, data including at least: an interior ambient temperature of the vehicle 100, an exterior ambient temperature of the vehicle 100, a solar load, a current speed of the vehicle 100, etc. Other environmental/automotive parameters may also be detected and reported by the plurality of interior and exterior environmental sensors 122. Once each sensor collects data reflecting a current environmental condition of the vehicle 100, it is available for reporting to the climate control module 116.

The plurality of interior and exterior environmental sensors 122 are polled by the climate control module 116 continuously, at time intervals that have been pre-determined. The specific length of a time interval for this polling process is a design parameter and, in some embodiments, is selected and programmed into the system according to the preference of the designer. In other embodiments, the time interval for polling the interior and exterior environmental sensors 122 may be chosen to optimize performance of the climate control system 108 of the vehicle 100.

FIG. 5 is a flow chart that illustrates an embodiment of a process 500 of operating a climate control system using a clothing insulative factor. First, the process 500 receives a user-defined temperature condition (step 502). The user-defined temperature condition is received via a user interface (shown as 118 in FIG. 1). In certain embodiments, the user-defined temperature condition is a set-point, and in certain embodiments, this set-point falls within a temperature range of 61 degrees Fahrenheit to 89 degrees Fahrenheit. A set-point, as selected and input by a user, indicates a level of thermal comfort desired to be felt by the user. In some embodiments, this level of thermal comfort may include an exact temperature condition to be maintained by the climate control system of the vehicle, or may include a variation of an exact temperature condition based upon the current clothing level of the user. In certain embodiments, a user enters information regarding a set-point that may be applied to only one region of the passenger compartment of a vehicle which has an independent climate control delivery system.

Next, the process 500 determines a clothing insulative factor (step 504) of an occupant of the vehicle. Generally, once an occupant has entered his/her chosen set-point via the user interface, a clothing insulative factor is then determined for that occupant using data collected by one or more thermal data collecting sensors (shown as 120 in FIG. 1). Each thermal data collecting sensor performs a scan of a pre-determined area of the passenger compartment, as described above with reference to FIGS. 1 and 4. The scan provides temperature data, such as an IR thermal mapping (depicted in FIG. 4), of the pre-determined area, detailing present temperature data as a color-coded grid.

The scanned data is then forwarded to the climate control module (shown as 116 in FIG. 1), where the system is able to ascertain which distinct areas of the thermal mapping correspond to the specific areas of the occupant to which they belong. Generally, within a particular climate controlled passenger zone (shown as 128 in FIG. 1), an occupant will typically be positioned in one of a few different possible poses. Using the thermal mapping, the climate control module may locate the “hot” and “cold” temperature zones, and determine the location of different regions of the occupant (e.g., the face, chest, lap, legs, and possibly arms). For example, the face of the occupant will likely appear to have higher temperature readings than the other areas of the occupant that have been scanned by the thermal data collecting sensors. In a similar fashion, the climate control module may determine the location of other areas of the occupant, including the scanned chest, lap, one or more legs, and/or arms of the occupant.

The climate control module then analyzes the data for the “hot” and “cold” zones that have been located using the data supplied by the thermal data collecting sensors to determine a clothing insulative factor using the temperature data for each occupant of the vehicle. Generally, a difference between temperature data for a “cold” zone (a scanned area of an occupant that has been determined to be covered with clothing) and a “hot” zone (a scanned area of an occupant that has been determined not to be covered with clothing) is calculated. This calculated difference is then correlated to one of a plurality of pre-determined levels of clothing insulation. In certain embodiments, the plurality of pre-determined levels of clothing insulation may be stored in the climate control module. For example, in some embodiments, the climate control module collects IR mapped temperature data at the face of an occupant (a “hot” zone that is not covered with clothing) and IR mapped temperature data at the leg of an occupant (a “cold” zone that is covered with clothing). In this embodiment, the climate control module determines a difference between the two temperatures and correlates this difference with one of a plurality of pre-defined levels of clothing insulation stored in its onboard memory.

In other embodiments, there may be no distinguishable “hot” zone. For example, when an occupant is wearing heavy winter clothing including a ski mask to cover his/her face, the IR mapped temperature data will not illustrate a “hot” zone because there is no scanned area that is determined not to be covered with clothing. In this case, the climate control module will set default values for the clothing insulative factor based on a seasonal expectation of the average occupant. In certain embodiments, these default values may be pre-determined values stored within the climate control module.

In certain embodiments, these pre-defined levels of clothing insulation are stored in the climate control module, to be accessed when necessary to assign a level of clothing insulation to an occupant. The levels of clothing insulation are pre-defined and loaded into the system during a calibration process that is performed initially and before the vehicle goes into production, using one person wearing varying levels of clothing within a constant temperature condition.

In some embodiments, a clothing insulative factor of 1.0 indicates an “average” level of clothing insulation worn by an occupant of the vehicle. In some embodiments, a clothing insulative factor of less than 1.0 indicates a “low” level of clothing insulation worn by an occupant, which would be associated with an occupant wearing lighter clothing, such as shorts and a lightweight shirt, for example. In some embodiments, a clothing insulative factor of greater than 1.0 indicates a “high” level of clothing insulation worn by an occupant, which would be associated with an occupant wearing heavier clothing.

Generally, there is an allocated “baseline” or nominal value for a clothing insulative factor, based upon current environmental conditions, according to data collected by a plurality of interior and exterior environmental sensors. When an occupant is wearing clothing that is determined to be more or less insulative than this baseline value, the process 500 adjusts to accommodate those deviations from the baseline.

The process 500 then calculates a model temperature condition based on the user-defined temperature condition and the clothing insulative factor (step 506). As detailed in the previous two examples, a model temperature condition may include a temperature that is higher or lower than the set-point input by an occupant, due to the clothing insulative factor of that particular occupant and current environmental conditions (including temperature) of the vehicle. The model temperature condition represents a temperature condition which would accommodate thermal comfort of the occupant, where that condition of thermal comfort would be hypothetically achieved at an expected clothing insulative level (e.g., 1.0) and a desired ambient temperature (e.g., 72 degrees Fahrenheit). The model temperature condition adjusts the temperature requirements up or down based upon an actual clothing insulative factor of the occupant, as opposed to the theoretical 1.0 clothing insulative factor of the occupant.

After calculating a model temperature condition (step 506), the process 500 obtains a current existing temperature condition (step 508). The current existing temperature condition of the vehicle includes multiple factors, and using the plurality of interior and exterior environmental sensors within the climate control system of the vehicle, the process 500 is able to collect data regarding interior and exterior ambient temperatures, solar load, speed of the vehicle, etc. to determine a current interior temperature condition of the vehicle.

Next, the process 500 calculates a difference between the model temperature condition and the current existing temperature condition (step 510). In one example, a model temperature condition (as calculated in step 506) may be thought of as a “target” passenger compartment temperature condition, and the calculated difference between this “target” temperature condition and the actual temperature condition represents a distance to the target. The distance to the target is the amount of change required to achieve an occupant's desired temperature condition, or set-point.

The process 500 then changes at least one of a plurality of parameters to adjust the current existing temperature condition based on the calculated difference between the model temperature condition and the current existing temperature condition (step 512). The difference between the model temperature condition and the current existing temperature condition is a quantified gap between the two temperature conditions, and indicates how much and in what direction the current existing temperature condition needs to be altered to achieve thermal comfort for the occupant. The current existing temperature condition may be adjusted toward the model temperature condition through configuration of three separate parameters of the climate control system 108: (1) discharge air temperature; (2) fan speed; and (3) air delivery mode.

The discharge air temperature is regulated by the air conditioning/heating system which is part of the climate control system 108. The discharge air temperature is configured to increase (i.e., to become warmer and increase the temperature inside the vehicle) when the set-point selected by an occupant is higher than an existing temperature condition of the passenger compartment. The discharge air temperature is further configured to decrease (i.e., to become cooler and decrease the temperature inside the vehicle) when the set-point selected by an occupant is lower than an existing temperature condition.

The fan speed indicates the speed of an internal fan, within the air conditioning/heating system, which is part of the climate control system. As the fan speed increases, it provides additional air speed and pressure for the air current discharged from the climate control system vents. This additional air speed and pressure increases the level of convection within the passenger compartment of a vehicle.

The air delivery mode indicates one or more particular climate control system vents through which air flow delivered by the air conditioning/heating system is delivered. In certain embodiments, the air flow delivery mode may consist of only one particular climate control system vent, providing increased air flow in one area and in one direction. In other embodiments, the air flow delivery mode may consist of a combination of multiple climate control system vents, providing increased air flow in more than one direction and/or in more than one area. In some embodiments, an air flow delivery mode consisting of a combination of several climate control system vents may provide lower-pressure air flow, with a decreased fan speed, and the ability to maintain a present level of thermal comfort.

Altering these three parameters (i.e., discharge air temperature, fan speed, and air delivery mode) allows the climate control system to regulate both the temperature and the level and direction of convection currents within the passenger compartment of a vehicle, creating a climate-controlled environment in which the thermal comfort of the occupant is achieved utilizing a single set-point, regardless of occupant clothing level. In certain embodiments, these calculations and adjustments occur continuously to achieve and maintain appropriate level(s) of thermal comfort. In some embodiments, the continuous calculation and adjustment includes a timed loop execution of the steps in the process 500.

In one example of execution of the process 500 in a hypothetical winter (cold-weather) condition, the process 500 anticipates a baseline clothing insulative factor valued at 1.0, and an occupant has input a set-point of 72 degrees Fahrenheit. The process 500 expects to make adjustments to various parameters to achieve an actual interior temperature that will feel like 72 degrees Fahrenheit to the occupant, based on the actual level of clothing worn by the occupant. This “feeling” of having achieved a chosen temperature is referred to as the thermal comfort of the occupant. The actual interior temperature that feels like 72 degrees Fahrenheit (which may be referred to as a model or desired temperature condition) may, in reality, be higher or lower than the occupant-chosen 72 degrees Fahrenheit. In this example, if the occupant has an actual clothing insulative factor value of 1.5, the process 500 recognizes this and adjusts the system parameters to achieve the model temperature condition, including regulated temperature and convection currents, in which the occupant will feel like it is 72 degrees Fahrenheit without removing any of his/her clothing. In this case, the process 500 heats the car to a slightly colder temperature than the desired 72 degrees Fahrenheit, so that the occupant maintains the same level of thermal comfort that would be achieved if the occupant had a clothing insulative factor of 1.0 and the temperature in the vehicle were actually 72 degrees Fahrenheit.

In a second example execution of the process 500 in a hypothetical winter condition, the process 500 again anticipates a baseline clothing insulative factor of 1.0, and an occupant has input a set-point of 72 degrees Fahrenheit. As in the previous example, the process 500 expects to make adjustments to various parameters to achieve an actual interior temperature that will feel like 72 degrees Fahrenheit to the occupant, based on the actual level of clothing worn by the occupant. Again, the thermal comfort level of the occupant is also referred to as the model or desired temperature condition. This thermal comfort level of the occupant, or in other words, the actual interior temperature that feels like 72 degrees Fahrenheit to the occupant, may, in reality, be higher or lower than 72 degrees Fahrenheit. In this example, if the occupant has an actual clothing insulative factor value of 0.8, the process 500 recognizes this and adjusts the parameters to achieve the model temperature condition, including regulated temperature and convection currents, in which the occupant will feel like it is 72 degrees Fahrenheit without adding any layers of clothing that would indicate a 1.0 clothing insulative factor. In this case, the process 500 heats the car to a slightly warmer temperature than the desired 72 degrees Fahrenheit, (in some embodiments, the process 500 would heat the vehicle to 74 degrees Fahrenheit) so that the occupant maintains the same level of thermal comfort that would be achieved if the occupant had a clothing insulative factor of 1.0 and the temperature in the vehicle were actually 72 degrees Fahrenheit.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method of operating an automatic climate control system of a motor vehicle, comprising:
determining a clothing insulative factor for an occupant of the motor vehicle;
calculating a model temperature condition based on a temperature set-point and the clothing insulative factor;
obtaining a current existing temperature condition;
calculating a difference between the model temperature condition and the current existing temperature condition; and
changing at least one of a plurality of parameters to adjust the current existing temperature condition based on the difference.

2. The method of claim 1, wherein the changing comprises changing at least one of:
a discharge air temperature of the automatic climate control system;
an air flow delivery mode of the automatic climate control system; and
a fan speed of the automatic climate control system.

3. The method of claim 1, wherein the determining further comprises:
obtaining a first infrared (IR) temperature reading of an uncovered region of an occupant of the motor vehicle;
obtaining a second IR temperature reading of a clothing-covered region of the occupant;
calculating a second difference between the first IR temperature reading and the second IR temperature reading; and
correlating the calculated second difference to one of a plurality of pre-defined clothing insulative factors.

4. The method of claim 1, wherein the obtaining a current existing temperature condition, the calculating a difference between the model temperature condition and the current existing temperature condition, and the changing at least one of a plurality of parameters, are performed continuously on a timed loop.

5. The method of claim 1, wherein the obtaining of the current existing temperature condition utilizes data from at least one of: an ambient temperature inside the motor vehicle, an ambient temperature outside the motor vehicle, a solar load, and a speed of the motor vehicle.

6. The method of claim 1, wherein the changing comprises changing the at least one of a plurality of parameters only within a pre-defined area of the motor vehicle associated with a location of the occupant.

7. The method of claim 1, further comprising:
determining a second clothing insulative factor for a second occupant of the motor vehicle;
calculating a second model temperature condition based on the temperature set-point and the second clothing insulative factor;
calculating a difference between the second model temperature condition and the current existing temperature condition; and
changing at least one of the plurality of parameters, in an area of the motor vehicle in which the second occupant is located, to adjust the current existing temperature condition based on the difference between the second model temperature condition and the current existing temperature condition.

8. A motor vehicle heating, ventilation, and air conditioning (HVAC) apparatus, comprising:
a user interface, configured to receive a user-selected temperature condition;
at least one infrared (IR) sensor, configured to collect temperature data;
a plurality of sensors, configured to collect and transmit environmental data when polled; and
an HVAC control unit, configured to:
determine a clothing insulative factor based on the collected temperature data;
calculate a corrected temperature condition based on the user-selected temperature condition and the clothing insulative factor;
obtain an existing temperature condition;
calculate a difference between the corrected temperature condition and the existing temperature condition; and
adjust the existing temperature condition toward the corrected temperature condition, based on the calculated difference.

9. The HVAC apparatus of claim 8, wherein the HVAC control unit adjusts the existing temperature condition by changing at least one of:
a discharge air temperature of the HVAC apparatus;
an air flow delivery mode of the HVAC apparatus; and
a fan speed of the HVAC apparatus.

10. The HVAC apparatus of claim 9, wherein the air flow delivery mode comprises a configuration of at least one designated HVAC vent through which air flow is discharged.

11. The HVAC apparatus of claim 8, wherein the HVAC control unit is further configured to:
obtain a first infrared (IR) temperature reading of a bare skin area of the occupant;
obtain a second IR temperature reading of a covered skin region of the occupant;
calculate a second difference between the first IR temperature reading and the second IR temperature reading; and
correlate the calculated second difference to one of a plurality of pre-defined clothing insulative factors.

12. The HVAC apparatus of claim 8, wherein the HVAC control unit is further configured to obtain the existing temperature condition, calculate the corrected temperature condition, and adjust the existing temperature condition continuously on a timed loop.

13. The HVAC apparatus of claim 8, wherein the HVAC control unit obtains the existing temperature condition utilizing data from at least one of the plurality of sensors, the data comprising: an ambient temperature inside the motor vehicle, an ambient temperature outside the motor vehicle, a solar load, and a speed of the motor vehicle.

14. The HVAC apparatus of claim 8, wherein the HVAC control unit adjusts the existing temperature condition only within a specific region of the motor vehicle associated with a location of an occupant.

15. A method of operating a motor vehicle automatic climate control system, comprising:
obtaining one of a plurality of pre-defined levels of clothing insulation for an occupant of a motor vehicle;
determining a modified temperature condition using the level of clothing insulation and a pre-defined temperature condition;
determining a current temperature condition;
calculating a difference between the modified temperature condition and the current temperature condition; and
adjusting fan speed, air flow delivery mode, and air flow output temperature of the automatic climate control system to reduce a difference between the current temperature condition and the modified temperature condition.

16. The method of claim 15, wherein the adjusting of the fan speed, air flow delivery mode, and air flow output temperature comprises adjusting only within a specific region of the motor vehicle corresponding to a location of the occupant.

17. The method of claim 15, wherein the air flow delivery mode comprises a configuration of at least one designated automatic climate control system output vent.

18. The method of claim 15, wherein the determining a current temperature condition comprises acquiring climatically relevant data of the interior and exterior surroundings of a motor vehicle.

19. The method of claim 18, wherein the acquiring climatically relevant data comprises polling a plurality of sensors to obtain data, wherein the data comprises: an ambient temperature inside the motor vehicle, an ambient temperature outside the motor vehicle, a solar load, and a speed of the motor vehicle.

20. The method of claim 15, wherein the step of obtaining one of a plurality of pre-defined levels of clothing insulation further comprises:
obtaining a first infrared (IR) temperature reading of a first defined region of the at least one occupant of the motor vehicle, wherein the first defined region comprises an uncovered region of the occupant;
obtaining a second IR temperature reading of a second defined region of the at last one occupant of the motor vehicle, wherein the second defined region comprises a region of the occupant that is covered with clothing;
calculating a second difference between the first IR temperature reading and the second IR temperature reading; and
correlating the calculated second difference to one of a plurality of pre-defined levels of clothing insulation.
